(19) United States
(12) Patent Application Publication
(10) Pub. No.: US 2007/0074243 A1
(43) Pub. Date: Mar. 29, 2007

(54) Inserting commercials in time-shifted broadcast content

(76) Inventors: Wilhemus Franciscus Johannes Verhaegh, Eindhoven (NL); Srinivas Gutta, Veldhoven (NL); Petrus Gerardus Meuleman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/578,832

(22) PCT Filed: Nov. 8, 2004
(86) PCT No.: PCT/IB04/52341

§ 371 Date: May 10, 2006

Related U.S. Application Data
(60) Provisional application No. 60/518,905, filed on Nov. 10, 2003.

(51) Int. Cl. H04N 7/10; H04N 7/025

(52) U.S. Cl. 725/32; 725/35; 725/36

(57) ABSTRACT

A method for inserting replacement commercials (7-10) into a data stream (100) is provided where the data stream has program (A, B, C) and commercial (1, 2) portions. The method including: detecting one or more of the commercial portions of the data stream; and replacing the detected one or more commercial portions with either more or less of the replacement commercial portions.

The present invention relates generally to broadcast content, and more particularly, to inserting commercials in time-shifted broadcast content.

It is known in the prior art to store commercials and inserting the same into a live broadcast stream by temporarily replacing the live stream by a playout of blocks from memory. Thus, commercial blocks in a live broadcast stream can be replaced by other commercial blocks that are of more interest to the user (e.g., local advertisements or commercials). In FIG. 1, stored content, e.g., commercials 3, 4, are inserted into a live broadcast stream 100 containing program blocks A, B, C by temporarily replacing the live. broadcast stream by a playout of commercial blocks, 3,4 from memory. In this way, the commercial blocks 1, 2 in the live broadcast stream 100 can be replaced by other commercial blocks 3, 4. The replaced commercial blocks 3, 4, in the new data stream 200 may be local advertisements or commercials that are of more interest to the user. However, in this approach, as illustrated in FIG. 1, the inserted block of commercials 3, 4, must last equally as long as the block 1, 2, that it replaces. This greatly limits the applicability of the approach.

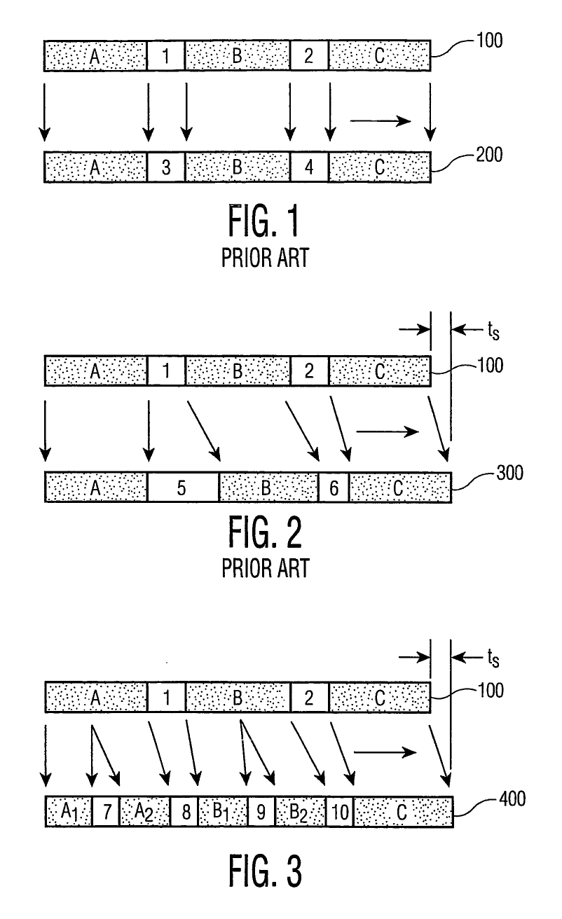

It is also known in the art to delay a live television broadcast stream 100 by means of an additional memory to replace the commercials 1, 2, in the live broadcast stream 100 with longer length commercials 5 or shorter length commercials 6, as is shown in FIG. 2. The receiver uses a memory not only to delay the program blocks A, B, C in the live broadcast stream 100 to create a delayed stream 300. As shown in FIG. 2, if the user wants to insert a longer commercial 5 than the available gap (1) in the live broadcast stream 100, the resumption of the live stream is delayed. However, this delay may be used in a next block of content to be replaced (2) to insert a new content block (6) that lasts shorter. In this way, more freedom is created to replace content blocks than is possible with the method of FIG. 1. However, in these processes the advertisers interests are not safeguarded because longer commercials, and sometimes entire commercials, are ignored by the viewers.

Therefore it is an object of the present invention to provide methods and devices that overcome these and other disadvantages associated with the prior art.

Accordingly, a method for inserting replacement commercials into a data stream is provided where the data stream has program and commercial portions. The method comprising: detecting one or more of the commercial portions of the data stream; and replacing the detected one or more commercial portions with either more or less of the replacement commercial portions.

The method can further comprise storing the commercial portions in the data stream subsequent to the detecting. In which case the replacing can comprise selecting the replacement commercial portions from at least one of the stored commercial portions from the data stream and other commercial portions from an external source. The method can further comprise storing the other commercial portions from the external source.

The method can further comprise detecting one or more of the program portions of the data stream and storing the one or more detected program portions.

The replacing can comprise indicating one or more preferences of a user. The indicating can be a manual indication by the user. The indicating can be an automatic indication from a recommendation system that forms a user profile, the user profile indicating viewing preferences of the user. The one or more preferences of the user can be selected from a group consisting of preferred replacement commercial portions, a preferred frequency of the replacement commercial portions, and a preferred length of the replacement commercial portions.

The method can further comprise outputting an output data stream having the program portions and the replacement commercial portions. Where the replacement commercial portions are more than the detected commercial portions, the method can further comprise dividing at least one of the program portions into sub-portions having at least one of the replacement commercial portions there between. Where the replacement commercial portions are less than the detected commercial portions, the method can further comprise combining at least two of the program portions into a larger program portion.

Also provided is a device for inserting replacement commercials into a data stream where the data stream has program and commercial portions. The device comprising: a detector device for detecting one or more of the commercial portions of the data stream; and a scheduler device for replacing the detected one or more commercial portions with either more or less of the replacement commercial portions.

The device can further comprise a memory for storing the commercial portions in the data stream subsequent to the detecting.

The device can further comprise a memory for storing other commercial portions from an external source. In which case the device can further comprise a second tuner operatively connected to the detector for receiving a second data stream having the other commercial portions.

The detector can further detect one or more of the program portions from the data stream wherein the device can further comprise a memory for storing (alternatively referred to as “delaying”) the one or more detected program portions.

The device can further comprise a first tuner operatively connected to the detector for receiving the data stream.

The data stream can be a broadcast video data stream, an audio data stream, or a streaming video data stream.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

FIG. 1 illustrates an original data stream in comparison with a data stream with replacement commercials, where the commercials in the original data stream are the same length as the replaced commercials in the data stream with replacement commercials, as is known in the prior art.

FIG. 2 illustrates an original data stream in comparison with a data stream with replacement commercials, where the commercials in the original data stream are replaced with commercials in the data stream with replacement commercials having a longer or shorter duration, as is also known in the prior art.

FIG. 3 illustrates an original data stream in comparison with a data stream with replacement commercials, where the commercials in the original data stream are less than the number of commercials in the data stream with replacement commercials.

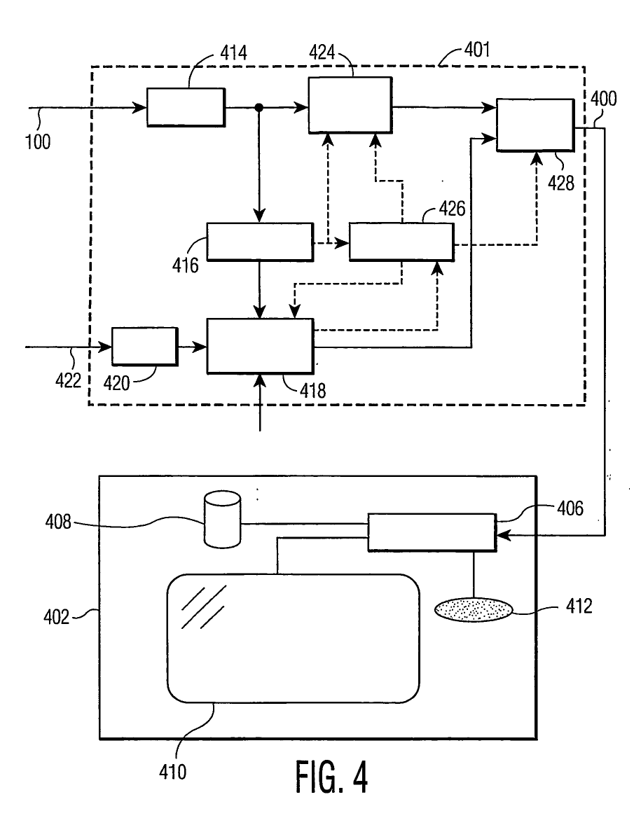

FIG. 4 illustrates a schematic of a device for carrying out the methods of the present invention.

Although this invention is applicable to numerous and various types of content, it has been found particularly useful in the environment of video content. Therefore, without limiting the applicability of the invention to video content, the invention will be described in such environment. However, those skilled in the art will appreciate that the methods of the present invention can utilize other types of content, such as audio content.

Referring now to FIG. 3, there is shown the same live broadcast data stream 100 as shown in FIGS. 1 and 2. Although, the invention is described below with regard to a “broadcast” data stream, those skilled in the art will appreciate that the same is discussed by way of example only and not to limit the invention thereto. For example, the invention is equally applicable to streaming video content as well which can be watched via the Internet using a broad-band network. However, the live broadcast data stream 100 is replaced with a data stream 400 in which the two larger commercial breaks 1, 2, are replaced by more, smaller commercial breaks 7-10. Although not shown, smaller commercial breaks in the live broadcast stream can also be replaced by less larger commercial breaks. Replacing a large number of small commercial breaks with less larger commercial breaks may require a time shift (delay) at the beginning of the data stream. The user can indicate a preference to either more smaller commercial breaks 7-10 or less larger commercial breaks via a suitable user interface. As also shown in the FIG. 3, the blocks A and B are divided into sub-blocks A₁, A₂ and B₁, B₂ each having a commercial inserted therebetween. Although shown divided into two sub-blocks, blocks A and B of the live broadcast data stream 100 can be divided into three or more sub-blocks. Block C is shown unchanged in FIG. 4 except for a time shift ts but can also be divided into two or more sub-blocks.

Referring now to FIG. 4, there is illustrated a schematic of a device 401 for carrying out the methods discussed above. In FIG. 4, video and commercial data streams are shown in solid lines while control signals are shown in broken lines. The device 401 can be an external device used in connection with a television 402 or display monitor, such as a computer, set-top box, VCR, DVD, or tuner in which case the live broadcast stream 100 can be a television broadcast signal, a cable signal, or a satellite signal. Although the device 401 is shown separable from the television 402, the device 401 can also be integral with the television 402. The television 100 includes a processor 406, storage device 408, display screen 410, and one or more speakers 412. The processor 406 is operatively connected to the storage device 408, display screen 410, and speaker 412 for controlling their operation which may be contained in a set of instructions on the storage device 408. The live broadcast data stream 100 may also be an audio stream where the device is a radio or other audio tuner. In such a configuration, the television 401 is replaced by an audio tuner, such as a broadcast or satellite radio which may or may not have a display screen 410.

In FIG. 4, a first tuner 414 receives the live broadcast data stream 100, containing programs A, B, C and commercials 1, 2. A detector 416 detects commercial boundaries in the live broadcast data stream 100, and the commercials 1, 2 are forwarded to a new-block memory 418. The detector 416 is preferably implemented as a processor which may also be operatively connected to a storage device containing a set of instructions for carrying out the methods of the present invention. The processor 406 of the television 402 may be integral with such detector 416 in which case it is operatively connected to one or more storage devices 408 containing sets of instructions for carrying out the normal functions of the television and the methods of the present invention. In addition to storing the original commercials 1, 2, from the live broadcast data stream 100, other commercials 7-10 may be received by a second tuner 420 from a second data stream 422 and stored into the new-block memory 418 as well. In this way, the new-block memory is filled with commercials to be used for insertion. The commercials can be those contained in the live broadcast data stream 100 and/or those from an alternative source (the second data stream 422), such as through a different network, e.g., the Internet. Alternative ways to fill the new-block memory 418 are well known in the art.

The detector 416 also detects which parts (e.g., A, B, C) of the live broadcast data stream 100 are programs (e.g., television shows), and controls a time-shift memory 424 to record (or otherwise delay) those parts. The new-block memory 418 and/or time-shift memory 424 may also serve as the storage device discussed above. Furthermore, although shown separable, the new-block memory 418 and time shift memory 424 may be a single storage device with portions assigned to the new-block memory 418 and time-shift memory 424. The detector 416 furthermore indicates the boundaries between commercials and programs to a scheduler 426. The scheduler 426 determines which commercials to insert and when. To this end, it knows which commercial blocks are in the new-block memory 418.

The scheduler 426 can also take user preferences into account, which can be input through a suitable user interface concerning the preferred commercials and preferred frequency and length of insertion of the commercials. The scheduler 426 can also automatically take into account user preferences through a recommendation system that builds a user profile based on either the viewing (or listening) habits of a user and/or the explicit recommendations of the user. Such recommendation systems are well known in the art. The scheduler 426 effectuates a constructed schedule by controlling a selector 428 that chooses the proper stream at each moment in time, and by controlling read-out of either the time-shift memory 424 or the new-block memory 418 and outputs such stream 400 to the television 402 (or audio tuner). The television 402 processes the output signal 400 in a conventional manner to display a video portion to a user on the display screen 410 and an audio portion on the speaker 412.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for inserting replacement commercials (7-10) into a data stream (100), the data stream having program (A, B, C) and commercial portions (1, 2), the method comprising:
detecting one or more of the commercial portions of the data stream; and
replacing the detected one or more commercial portions with either more or less of the replacement commercial portions.

2. The method of claim 1, further comprising storing the commercial portions in the data stream subsequent to the detecting.

3. The method of claim 2, wherein the replacing comprises selecting the replacement commercial portions from at least one of the stored commercial portions from the data stream and other commercial portions from an external source (422).

4. The method of claim 3, further comprising storing the other commercial portions from the external source.

5. The method of claim 1, further comprising detecting one or more of the program portions of the data stream and storing the one or more detected program portions.

6. The method of claim 1, wherein the replacing comprises indicating one or more preferences of a user.

7. The method of claim 6, wherein the indicating is a manual indication by the user.

8. The method of claim 6, wherein the indicating is an automatic indication from a recommendation system that forms a user profile, the user profile indicating viewing preferences of the user.

9. The method of claim 6, wherein the one or more preferences of the user are selected from a group consisting of preferred replacement commercial portions, a preferred frequency of the replacement commercial portions, and a preferred length of the replacement commercial portions.

10. The method of claim 1, further comprising outputting an output data stream (400) having the program portions and the replacement commercial portions.

11. The method of claim 10, wherein the replacement commercial portions are more than the detected commercial portions, the method further comprising dividing at least one of the program portions into sub-portions (A₁, A₂, B₁, B₂) having at least one of the replacement commercial portions therebetween.

12. The method of claim 10, wherein the replacement commercial portions are less than the detected commercial portions, the method further comprising combining at least two of the program portions into a larger program portion.

13. A device (401) for inserting replacement commercials (7-10) into a data stream (100), the data stream having program (A, B, C) and commercial portions (1, 2), the device comprising:
a detector device (416) for detecting one or more of the commercial portions of the data stream; and
a scheduler device (426) for replacing the detected one or more commercial portions with either more or less of the replacement commercial portions.

14. The device of claim 13, further comprising a memory (418) for storing the commercial portions in the data stream subsequent to the detecting.

15. The device of claim 13, further comprising a memory (418) for storing other commercial portions from an external source (422).

16. The device of claim 13, wherein the detector further detects one or more of the program portions from the data stream wherein the device further comprises a memory (424) for storing the one or more detected program portions.

17. The device of claim 13, further comprising a first tuner (414) operatively connected to the detector for receiving the data stream.

18. The device of claim 15, further comprising a second tuner (420) operatively connected to the detector for receiving a second data stream having the other commercial portions.

19. The device of claim 13, wherein the data stream is a broadcast video data stream.

20. The device of claim 13, wherein the data stream is a streaming video data stream.

21. The device of claim 13, wherein the data stream is an audio data stream.

22. A computer program product embodied in a computer-readable medium for inserting replacement commercials (7-10) into a data stream (100), the data stream having program (A, B, C) and commercial portions (1, 2), the computer program product comprising:
computer readable program code means for detecting one or more of the commercial portions of the data stream; and
computer readable program code means for replacing the detected one or more commercial portions with either more or less of the replacement commercial portions.

23. The method according to claim 1, wherein a program storage device readable by machine, tangibly embodying a program of instructions executable by the machine performs the method steps for inserting replacement commercials (7-10) into a data stream.
